(19) United States
(12) Patent Application Publication
(10) Pub. No.: US 2025/0264720 A1
(43) Pub. Date: Aug. 21, 2025

(54) HEAD-UP DISPLAY SYSTEM AND VEHICLE INCLUDING HEAD-UP DISPLAY SYSTEM

(71) Applicant: WUHU TIANMA AUTOMOTIVE ELECTRONICS CO., LTD., Wuhu (CN)

(72) Inventors: Ling SHEN, Wuhu (CN); Mingxin HUO, Wuhu (CN)

(21) Appl. No.: 19/198,206

(22) Filed: May 5, 2025

(30) Foreign Application Priority Data
Dec. 31, 2024 (CN) 202411999050.5

(51) Int. Cl. G02B 27/01; B60K 35/231; G02B 5/30

(52) U.S. Cl. CPC G02B 27/0101; B60K 35/231; G02B 5/3025; G02B 27/0149; G02B 2027/0123; G02B 2027/013; G02B 2027/015

(57) ABSTRACT

A head-up display system and a vehicle including a head-up display. The head-up display system includes an imaging unit, a reflector and a windshield of a vehicle, including a reflection portion and a transmission portion. The imaging unit forms first light and emits the first light to the reflection portion, the reflection portion reflects the first light to form second light, the reflection portion reflects the second light to the reflector, the reflector reflects the second light to form third light, the reflector reflects the third light to the transmission portion to form fourth light, the transmission portion reflects the fourth light to human eyes, and the fourth light forms a virtual image at a side of the windshield facing away from the human eyes. An optical path volume is reduced by multiplexing an optical path and multiplexing windshield reflection, to reduce a volume of the head-up display system.

### CROSS-REFERENCE TO RELATED APPLICATIONS

The present application claims priority to Chinese Patent Application No. 202411999050.5, filed on Dec. 31, 2024, the content of which is incorporated herein by reference in its entirety.

### TECHNICAL FIELD

The present disclosure relates to the field of head-up display, and in particular, to a head-up display system and a vehicle including the head-up display system.

### BACKGROUND

A head-up display (HUD) device is an important component of a smart vehicle that is currently being vigorously developed bin the world. Through the early promotion and application of HUD devices by major vehicle brands, an increasing number of car manufacturers and users have noticed the importance of HUD technology for safe driving. It enables a driver to obtain critical information such as a vehicle speed, navigation, road conditions, and a distance to other vehicle without their line of sight leaving the road. Its unique display position cannot be replaced by display devices in other positions in the vehicle. Therefore, more and more car manufacturers are equipping HUD devices in new vehicles, as a priority configuration to enhance driving safety.

The head-up display (HUD) industry currently faces a common problem, that is, consumers expect that the HUD display image should be as large as possible. However, due to the limitations of geometric optical principles used in the traditional HUD, achieving a larger display image requires an optical path having a certain length, which requires for two or more reflective lenses in the design. For the current reflective lens, a surface of the glass needs to be coated with a total reflective film to achieve high reflectivity, resulting in extremely low transmittance.

Consequently, the reflective lens shall be positioned outside the optical path, and occupies an additional independent space. Moreover, since each optical path operates independently, an overall volume of the HUD product increases. However, a structural space under the vehicle's dashboard is limited, and the HUD having a larger size may easily interfere with the dashboard's metal enclosure, the defrosting air outlet at the front windshield, installation brackets, and other components, making it difficult to arrange.

Therefore, developing a more compact optical path spatially multiplexing HUD optical path structure has very practical significance.

### SUMMARY

A purpose of the present disclosure is to provide a spatially multiplexing HUD imaging optical path structure, which aims to reduce the number of reflectors and the volume of the optical path space by multiplexing an optical path space on a premise of achieving a same image size, thereby reducing an overall volume of HUD and thus saving the space.

To achieve the above purpose, the embodiments of the present disclosure provide the following technical solutions.

The present disclosure provides a head-up display system, includes an imaging unit, a reflector and a windshield of a vehicle. The windshield includes a reflection portion and a transmission portion. The imaging unit forms first light and emits the first light to the reflection portion, the reflection portion reflects the first light to form second light, the reflection portion reflects the second light to the reflector, the reflector reflects the second light to form third light, the reflector reflects the third light to the transmission portion to form fourth light, the transmission portion reflects the fourth light to human eyes, and the fourth light forms a virtual image at a side of the windshield facing away from the human eyes.

Based on a same concept, the present disclosure further provides a vehicle including the head-up display system described above.

Compared with the related art, the beneficial effects of the present disclosure based on the imaging optical path structure of the spatially multiplexing head-up display system of the windshield of the vehicle are as follows. According to the above technical solutions of the present disclosure, a generation unit, a reflector and a windshield are included. The windshield includes a transmission portion and a reflection portion. The reflection portion is located in an optical path between an imaging unit and the reflector. An imaging light beam emitted from the image generation unit is directed to the reflection portion, then is reflected to the reflector, then is reflected to the transmission portion of the windshield, and finally is converged at the eye position of a driver to realize a display function. In this case, within a same HUD imaging field of view (FOV), the present disclosure can realize a smaller product volume, which can be arranged in more vehicles, so that the contradiction between achieving a large image and achieving a small volume in the HUD industry can be solved. In addition, according to the technical solutions of the present disclosure, a larger display image can be achieved with a similar product volume, and can bring a larger FOV and make the ARHUD screen wider and higher, thereby covering more and farther lanes. When there are dangerous factors during vehicle driving, the factors can be projected on the ARHUD earlier, and the driver can receive early warnings, thereby improving the safety of vehicle driving.

### BRIEF DESCRIPTION OF DRAWINGS

In order to better describe the technical solutions of embodiments of the present disclosure or the related art, the following briefly describes the drawings desired in the embodiments or the related art. It should be noted that, the drawings described below are merely some embodiments of the present disclosure, and for those skilled in the art, other drawings may be obtained based on these drawings without creative efforts.

FIG. 1 is a schematic diagram of a head-up display system in the related art;

FIG. 2 is a schematic diagram of a head-up display system according to an embodiment of the present disclosure;

FIG. 3 is a schematic diagram of an imaging unit according to an embodiment of the present disclosure;

FIG. 4 is a schematic diagram of a windshield according to an embodiment of the present disclosure;

FIG. 5 is a schematic diagram of another windshield according to an embodiment of the present disclosure;

FIG. 6 is a schematic diagram of a quarter-wave plate according to an embodiment of the present disclosure;

FIG. 7 is a schematic diagram of another head-up display system according to an embodiment of the present disclosure;

FIG. 8 is a schematic diagram of another head-up display system according to an embodiment of the present disclosure;

FIG. 9 is a schematic diagram of another head-up display system according to an embodiment of the present disclosure;

FIG. 10 is a schematic diagram of a height adjustment structure according to an embodiment of the present disclosure; and

FIG. 11 is a schematic diagram of a vehicle according to an embodiment of the present disclosure.

### DESCRIPTION OF EMBODIMENTS

Technical solutions in embodiments of the present disclosure will be described below in connection with the drawings in the present disclosure. It should be noted that, the described embodiments are only a part of the embodiments of the present disclosure, not all of them. Based on the embodiments of the present disclosure, all other embodiments obtained by those skilled in the art without any creative efforts shall fall within the protection scope of the present disclosure.

Embodiments in this specification are described in a progressive manner, each of the embodiments emphasizes the difference from other embodiments, and the same or similar parts among the embodiments can be referred to each other. For the device disclosed in the embodiments, as it corresponds to the method disclosed in the embodiments, the description is relatively simple. For relevant information, please refer to the method description.

In addition, if the embodiments of the present disclosure relate to description of “first”, “second”, and the like, the description of “first”, “second”, and the like are merely used for description, and cannot be understood as indicating or implying relative importance or implicitly indicating a quantity of indicated technical features. Therefore, features defined by “first” and “second” may explicitly or implicitly include at least one of the features. In addition, the meaning of “and/or” appearing throughout includes three parallel solutions. Taking “A and/or B” as an example, it includes: A alone, B alone, or A and B. In addition, the technical solutions among the embodiments may be combined with each other, but must be based on that those skilled in the art can implement these technical solutions. When the combination of the technical solutions contradicts each other or cannot be implemented, it should be considered that the combination of the technical solutions does not exist or does not fall within the protection scope of the present disclosure.

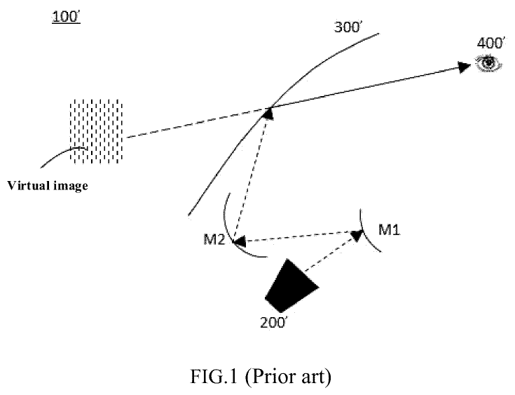

At present, the design of the HUD imaging system in the market mostly adopts a “Z”-shaped optical path. As shown in FIG. 1, which is a schematic diagram of a head-up display system provided in the related art. The head-up display system adopts a conventional solution, including at least two reflectors, and the reflectors are opaque and must be arranged to be separate from the main optical path, thereby needing to additionally occupy an independent space, as a result, the whole occupies a relatively large space. In an embodiment, referring to FIG. 1, in the related art, a head-up display system 100′ includes an imaging unit 200′, a first reflector M1, a second reflector M2 and a windshield 300′. The imaging unit 200′ is provided inside a vehicle instrument panel, and emitted light faces the first reflector M1. The first reflector MI is provided at a side of the imaging unit 200′ close to a driver (a human eye 400′), and receives light emitted from the imaging unit 200′, and reflects the received light to the second reflector M2. The first reflector M1 is a planar reflector or a free-form mirror. The second reflector M2 is provided at a side of the first reflector MI away from the driver (the human eye 400). The second reflector M2 is a free-form mirror, receives light reflected from the first reflector M1, reflects the light to the windshield 300′, and after being reflected by the windshield 300′, the light is directed to the vicinity of the position of the driver (the human eye 400′), and a virtual image is formed at a side of the windshield 300′ away from the driver (the human eye 400′), thereby realizing the head-up display. In the related art, the whole optical path is as follows: the imaging unit 200′. the first reflector MI +the second reflector M2→the windshield 300′→the driver (the human eye 400′), and the whole optical path is independent of each other. To obtain a large-sized virtual image, it needs to enlarge the light-emitting area of the imaging unit 200′ or the reflection area of the first reflector M1 and the reflection area of the second reflector M2 in the whole optical path. However, the light-emitting area of the imaging unit 200′ or the reflection area of the first reflector MI and the reflection area of the second reflector M2 are difficult to increase arbitrarily due to the limitation of the space of the head-up display system 100′ of the vehicle.

The present disclosure proposes an imaging optical path structure of the spatially multiplexing head-up display system of the windshield of the vehicle. According to the technical solutions adopted by the imaging optical path structure of the spatially multiplexing head-up display system of the windshield of the vehicle in the present disclosure, a reflection portion is arranged at a lower side of the windshield to replace a reflector, and multiplexing the optical paths between respective components of the head-up display system can maximize the compression of the optical path space. Therefore, the occupied space of the head-up display system can be further saved.

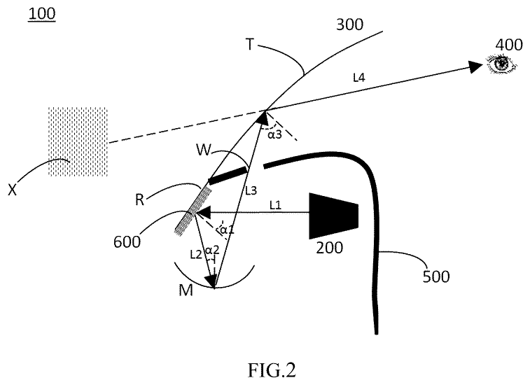

In an embodiment, FIG. 2 is a schematic diagram of a head-up display system according to an embodiment of the present disclosure. As shown in FIG. 2, the head-up display system 100 includes an imaging unit 200, a reflector M, and a windshield 300 of a vehicle. The windshield 300 includes a reflection portion R and a transmission portion T. The imaging unit 200 forms first light L1 and emits the first light L1 to the reflection portion R. The reflection portion R reflects the first light L1 to form second light L2. The reflector M receives the second light L2 and reflects the second light L2 to form third light L3. The reflector M reflects the third light L3 to the transmission portion T. Fourth light L4 is formed after being reflected by the transmission portion T, and the fourth light L4 forms a virtual image X on the other side of the windshield 300 relative to a human eye 400.

In the embodiments of the present disclosure, by providing the reflection portion R on the windshield and multiplexing the reflection portion R of the windshield 300 for reflection, the number of reflectors in the head-up display system 100 can be reduced, and thus a volume of the head-up display system 100 can be reduced.

In the embodiments of the present disclosure, the imaging unit 200 is a pattern generation unit that can convert an electrical signal into an optical signal. As a non-limiting example, the imaging unit 200 includes a display device that can emit image light, or a real image or a virtual image formed by a display device through refraction, reflection, and the like. For example, the imaging unit 200 may be a liquid crystal displayer, an LED (Light-Emitting Diode), an OLED (Organic Light-Emitting Diode), or an active light-emitting dot matrix screen composed of light-emitting point light sources, such as, plasma light-emitting points. The imaging unit 200 may also be a projection imaging device based on projection technologies such as DLP (Digital Light Provision), LCOS (Liguid Crystalon Silicon), liquid crystal, driven by a light source such as LED, OLED, laser, fluorescence, or a combination thereof, reflected or transmitted by a display panel such as DMD (Digital Micromirror Device), LCOS, and LCD, and then projected on a projection screen for imaging through a projection lens. The imaging unit 200 may also be a projection imaging device by scanning to image by a laser beam on a screen. Moreover, a real image or a virtual image formed by one or more times of refraction or reflection of all the above display devices may also be used as the imaging unit 200.

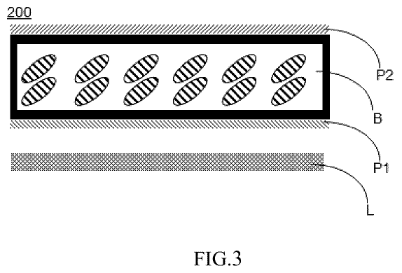

In some embodiments, the imaging unit 200 is a liquid crystal displayer, as shown in FIG. 3, the liquid crystal displayer includes an upper polarizer P2 and a lower polarizer P1 at upper and lower sides of a liquid crystal box B. The upper polarizer P2 and the lower polarizer PI modulate the light emitted by a backlight unit L below the liquid crystal box B to be linearly polarized light, and an absorption axis of the upper polarizer is perpendicular to an absorption axis of the lower polarizer.

In some embodiments, as shown in FIG. 2, the first light L1 intersects with the third light L3. The imaging optical path of the head-up display system 100 changes from a traditional “Z”-shaped optical path to a “A”-shaped optical path, which is more conducive to folding of the optical path, and thus the optical path is compact in terms of the structure, thereby reducing the space volume of the optical path and the volume of the head-up display system 100. In addition, only one reflector M is provided in the embodiments of the present disclosure, thereby reducing one reflector compared with a traditional imaging optical path, thus saving the volume occupied by the reflector, and reducing the volume of the head-up display system 100.

In some other embodiments, as shown in FIG. 2, the head-up display system further includes an instrument panel 500. The instrument panel 500 is provided with an opening W. The imaging unit 200, the reflector M and the reflection portion R of the windshield 300 are all provided inside the instrument panel 500, and the third light L3 is projected to the transmission portion T through the opening M. In the embodiments of the present disclosure, the imaging unit 200, the reflector M, and the reflection portion R are all arranged inside the instrument panel 500, thereby preventing interference from external light. The third light L3 passes through the opening W and is directed to the outside of the instrument panel 500, then a virtual image X is formed after being reflected by the transmission portion T of the windshield 300.

In an embodiment, the reflector M may be a curved reflector. In an example, the curved reflector may be a concave reflector. A surface of the concave reflector facing the opening W of the instrument panel 500 is a concave curved surface, and the image light is reflected and converged after passing through the concave reflector. According to the imaging principle of the head-up display system, it is known that the image light emitted by the image imaging unit 200 changes the propagation direction after being reflected by the reflection portion R of the windshield 300, and then is directed to the curved reflector M, and the reflected image light is emitted out of the instrument panel 500 through the opening W of the instrument panel 500, and forms a virtual image after being reflected by an external reflection medium (such as a reflection imaging part). The external reflective medium generally includes the windshield 300 of the vehicle, or an additional transparent imaging window, which is generally a planar surface or a curved surface that is close to a plane. Therefore, the reflection of light on the windshield 300 is close to the specular reflection, that is, the external reflective medium has less influence on the imaging distance, and the imaging distance of the head-up display system is mainly determined by the curved reflector M. When the curved reflector is a concave reflector (i.e., the reflective surface is a concave curved surface), if the distance between the imaging unit 200 and the concave reflector is less than a focal length of the concave reflector, the concave reflector forms an upright enlarged virtual image based on the image output by the imaging unit 200. For example, according to the imaging property of the concave reflector, when the optical distance between the imaging unit 200 and the concave reflector is less than a focal length of the concave reflector (that is, the image display portion is located within one time of the focal length of the concave reflector), an image distance of the concave reflector increases as the distance between the imaging unit 200 and the concave reflector increases, that is, the larger the distance between the imaging unit 200 and the concave reflector, the larger the imaging distance using the head-up display system. Therefore, the imaging distance of the virtual image finally formed by different display portions can be adjusted by adjusting a distance between different display portions and the curved reflective element.

In some embodiments, as shown in FIG. 2, the reflection portion R of the windshield 300 is provided on the lower side of the windshield 300, and the reflection portion R is provided with a reflective layer 600. The reflective layer 600 is provided on the inner side of the windshield 300, that is, a side close to the human eye 400, thereby avoiding damage from an external force, such as the repeated wiping action of the windshield wipers, which would easily cause the reflective film layer 600 to fall off from the windshield 300 or get damaged.

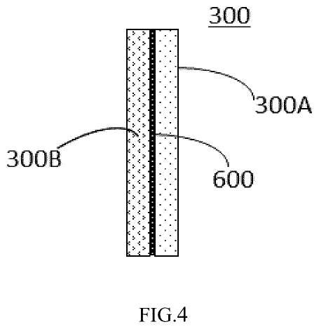

In some embodiments, as shown in FIG. 4, which is a schematic diagram of a windshield 300 according to the present disclosure, the windshield 300 is laminated glass, including a first glass plate 300A located at a side close to the human eye, a second glass plate 300B located at a side away from the human eye, and a reflective layer 600 provided between the first glass plate 300A and the second glass plate 300B, thereby preventing the reflective layer 600 from being damaged by the external force. For example, in addition to preventing the reflective wipers from scraping and damaging the reflective layer 600, the windshield 300 can be further prevented from damaging the reflective layer 600 during the installation.

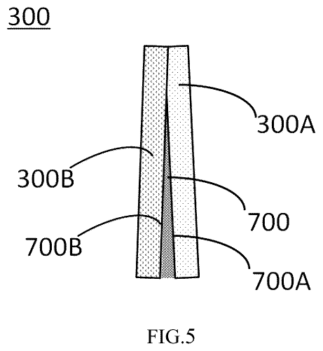

In some embodiments, as shown in FIG. 5, which is a schematic diagram of another windshield 300 provided in the present disclosure, the windshield 300 includes a first glass plate 300A, a second glass plate 300B, and a wedge-shaped film 700 sandwiched between the first glass plate 300A and the second glass plate 300B. The material of the wedge-shaped film 700 is typically polyvinyl butyral (PVB), which is used to bond and fix the first glass plate 300A and the second glass plate 300B together. It can be understood that the material of the wedge-shaped film 700 in the embodiments of the present disclosure is not limited thereto, and polycarbonate (PC), polyvinyl chloride (PVC), ethylene vinyl acetate (EVA), polyacrylate (PA), polymethyl methacrylate (PMMA) or polyurethane (PUR) may also be selected. The wedge-shaped film 700 includes a first surface 700A and a second surface 700B opposite to each other. The first surface 700A faces the first glass plate 300A. The second surface 700B faces the second glass plate 300B. The reflective layer 600 is provided between the first glass plate 300A and the first surface 700A of the wedge- shaped film 700 (not shown in the figure). In some embodiments, the reflective layer 600 may be provided between the second glass plate 300B and the second surface 700B of the wedge-shaped film 700 (not shown in the figure).

In some embodiments, the reflective layer 600 may be one or a combination of a coating film, a transfer film, a screen printing film, a sputtering film, and an evaporation coating film. In an embodiment, the reflective layer 600 may be formed by a method of printing black ink. As a printing method, a rod coating method, a reverse coating method, a gravure coating method, a die coating method, a roller coating method, a screen printing method, and the like can be used. However, the printing can be performed on various substrates on the basis of simple printing, and in addition, the screen printing method is preferred in consideration of the aspect of printing according to the size of the windshield 300.

In some other embodiments, the reflective layer 600 may also be formed of a metal reflective film or an organic reflective film. In an example, the reflective layer 600 may be a metal reflective film composed of any metal of gold, silver, or copper, or may be one or a combination of aluminum, silver, aluminum alloy, or silver alloy material, or may be composed of an organic light reflective film such as a polyethylene terephthalate plastic film (PET film).

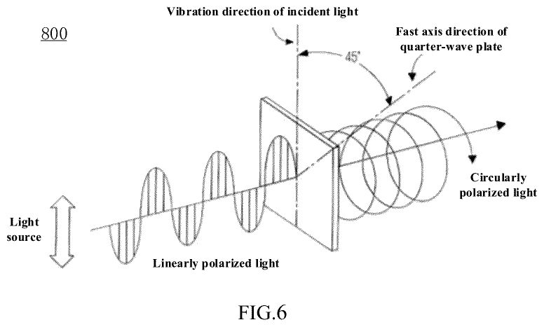

FIG. 6 is a schematic diagram of a quarter-wave plate according to an embodiment of the present disclosure. As shown in FIG. 6, in this embodiment, the quarter-wave plate 800 has different refractive indexes (that is, different propagation speeds) for incident light in different polarization directions. The quarter-wave plate 800 controls the material and thickness so that after the light passes through the quarter-wave plate, the light in two different different polarization directions have a quarter-wavelength phase difference. The light synthesized at this phase difference is circularly polarized light. A fast axis of the quarter-wave plate 800 and the polarization direction of the incident light beam (P light) form an included angle of 45°, which results in an imaging beam being modulated to be right-handed circularly polarized light. The right-handed circularly polarized light is reflected and modulated to be linearly polarized light (S light) after passing through the quarter-wave plate again. Or, the fast axis of the quarter-wave plate 800 and the polarization direction of the incident light beam (S light) form an included angle of 45°, which results in an imaging beam being modulated to be left-handed circularly polarized light. The left-handed circularly polarized light is reflected and then modulated to be linearly polarized light (P light) (not shown) after passing through the quarter-wave plate again. Therefore, the polarized light of the first light L1 and the polarized light of the third light L3 have different polarization directions, achieving the composite utilization of two light beams in a same space without interference, thus compressing the optical path space of the head-up display system 100, making the structure of the head-up display system more compact.

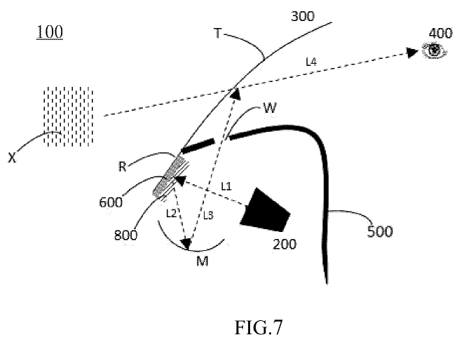

In some embodiments, the reflection portion R is provided with a quarter-wave plate 800, FIG. 7 is a schematic diagram of another head-up display system 100 provided by an embodiment of the present disclosure. As shown in FIG. 7, the first light L1 emitted by the imaging unit 200 is directed to the reflection portion R, passes through the quarter-wave plate 800 and then reaches the surface of the reflection portion R, and is reflected by the reflection portion R to form the second light L2. The second light L2 passes through the quarter-wave plate 800 again and is then directed to the reflector M, and is then reflected by the reflector M to form the third light L3. The third light L3 is directed to the transmission portion T of the windshield 300, and is finally reflected by the windshield 300 to form the fourth light L4, which is converged in the vicinity of the position of the human eye 400 of the driver to realize the display function.

The specific working principle adopted by this embodiment is as follows. The imaging beam of the first light L1 emitted by the imaging unit 200 may be linearly polarized light S having a specific polarization direction, and passes through the quarter-wave plate 800; and after modulation by the quarter-wave plate 800, an orientation of a vibration plane of the first light L1, which is S-polarized light, rotates by 45° to form left-handed circularly polarized light. Then the first light L1 (i.e., left-handed circularly polarized light) is directed to the reflection portion R. The reflective layer 600 with a reflective function is provided on a surface of the reflection portion R facing the imaging unit 200. The first light L1 is reflected by the reflective film layer 600 to form the second light L2. The second light L2 is also left-handed circularly polarized light. The reflection film layer 600 reflects the second light L2 (i.e., left-handed circularly polarized light) to the reflector M, and the second light L2 passes through the quarter-wave plate 800 again. After modulation by the quarter-wave plate 800, an orientation of a vibration surface of the second light L2 (i.e., left-handed circularly polarized light) rotates by 45° again to form P-polarized light. The second light L2 (i.e., P-polarized light) then reaches the surface of the reflector M. The second light L2 is reflected by the reflector M to form third light L3, which is also P-polarized light. The third light L3 is reflected to the transmission portion T of the windshield 300, and is then reflected by the transmission portion T of the windshield 300 to form the fourth light L4, which is finally converged in the vicinity of the human eye 400 in the form of P-polarized light, which is linearly polarized light.

Alternatively, the imaging beam of the first light L1 emitted by the imaging unit 200 may be linearly polarized light P having a specific polarization direction, and passes through the quarter-wave plate 800; and after modulation by the quarter-wave plate 800, an orientation of ta vibration plane of the first light L1, which is P-polarized light, rotates by 45° to form right-handed circularly polarized light. The first light L1 (i.e., right-handed circularly polarized light) is then directed to the reflection portion R. The reflective layer 600 with a reflective function is provided on a surface of the reflection portion R facing the imaging unit 200. The first light L1 is reflected by the reflective film layer 600 to form the second light L2. The second light L2 is also right- handed circularly polarized light. The reflection film layer 600 reflects the second light L2 (i.e., right-handed circularly polarized light) to the reflector M, and the second light L2 passes through the quarter-wave plate 800 again. After modulation by the quarter-wave plate 800, an orientation of a vibration surface of the second light L2 (i.e., right-handed circularly polarized light) rotates by 45° again to form S-polarized light. The second light L2 (i.e., S-polarized light) then reaches the surface of the reflector M. The second light L2 is reflected by the reflector M to form the third light L3, which is also S-polarized light. The third light L3 is reflected to the transmission portion T of the windshield 300, and is then reflected by the transmission portion T of the windshield 300 to form the fourth light L4, which is finally converged in the vicinity of the human eye 400 in the form of S-polarized light, which is linearly polarized light.

Since the reflection portion R attached to or coated with the quarter-wave plate 800 can change the polarization direction of the light, the polarized light of the first light L1 and the polarized light of the third light L3 can have different polarization directions, thereby achieving the composite utilization of two light beams in a same space without interference, thus compressing the optical path space of the head-up display system 100, making the structure of the head-up display system more compact.

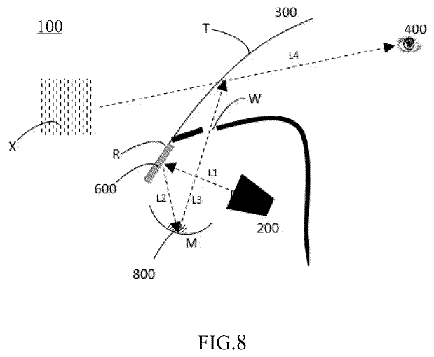

In some embodiments, the reflector M is provided with a quarter-wave plate 800, FIG. 8 is a schematic diagram of another head-up display system 100 provided by an embodiment of the present disclosure. As shown in FIG. 8, the first light L1 emitted from the imaging unit 200 is directed to the reflection portion R, and the first light L1 is reflected by the reflection portion R to form the second light L2. The second light L2 is directed to the reflector M, and passes through the quarter-wave plate 800 and then reaches the surface of the reflector M, and then is reflected by the reflector M to form the third light L3. The third light L3 passes through the quarter-wave plate 800 again and then is directed to the transmission portion T of the windshield 300, and is finally reflected by the windshield 300 to form the fourth light L4, which is converged in the vicinity of the position of the human eye 400 of the driver, thereby realizing the display function.

The specific working principle adopted by the embodiments of the present disclosure is as follows. The imaging beam of the first light L1 emitted from the imaging unit 200 is linearly polarized light S having a specific polarization direction, the first light L1 is directed to the reflection portion R. The reflective layer 600 with a reflective function is provided on a surface of the reflection portion R facing the imaging unit 200. The first light L1 is reflected by the reflective film layer 600 to form the second light L2. The second light L2 is also S-polarized light, which is linearly polarized light. After passing through the quarter-wave plate 800 and being modulated by the quarter-wave plate 800, an orientation of a vibration surface of the second light L2 of the S-polarized light is rotated by 45°, to form left-handed circularly polarized light. The second light L2 (i.e., left-handed circularly polarized light) is directed to the surface of the reflector M. After being reflected by the reflector M, the third light L3, which is also left-handed circularly polarized light, is formed. The third light L3 passes through the quarter-wave plate 800 again, and after modulation by the quarter-wave plate 800, an orientation of a vibration surface of the left-handed circularly polarized light is rotated by 45° again, to form P-polarized light. The third light L3 (P-polarized light) is directed to the transmission portion T of the windshield 300, and is reflected by the transmission portion T of the windshield 300 to form the fourth light L4, which is finally converged in the vicinity of the human eye 400 in the form of P-polarized light, which is linearly polarized light.

Alternatively, the imaging beam of the first light L1 emitted from the imaging unit 200 is linearly polarized light P having a specific polarization direction, the first light L1 is directed to the reflection portion R. The reflective layer 600 with a reflective function is provided on a surface of the reflection portion R facing the imaging unit 200. The first light L1 is reflected by the reflective film layer 600 to form the second light L2, which is also P-polarized light (linearly polarized light). After passing through the quarter-wave plate 800 and being modulated by the quarter-wave plate 800, an orientation of a vibration surface of the second light L2 of the P-polarized light is rotated by 45°, to form right-handed circularly polarized light. The second light L2 (i.e., right-handed circularly polarized light) is then directed to the surface of the reflector M. After being reflected by the reflector M, the third light L3, which is also right-handed circularly polarized light, is formed. The third light L3 passes through the quarter-wave plate 800 again. After modulation by the quarter-wave plate 800, an orientation of a vibration surface of the right-handed circularly polarized light is rotated by 45° again, to form S-polarized light. Then, the third light L3, which is S-polarized light, is directed to the transmission portion T of the windshield 300. Then, the third light L3 is reflected by the transmission portion T of the windshield 300 to form the fourth light L4, which is finally converged in the vicinity of the human eye 400 in the form of S-polarized light, which is linearly polarized light.

Similarly, since the reflector R attached to or coated with the quarter-wave plate 800 can change the polarization direction of the light, the polarized light of the first light L1 and the polarized light of the third light L3 have different polarization directions, thereby achieving the composite utilization of two light beams in a same space without interference, thus compressing the optical path space of the head-up display system 100, making the structure of the head-up display system more compact.

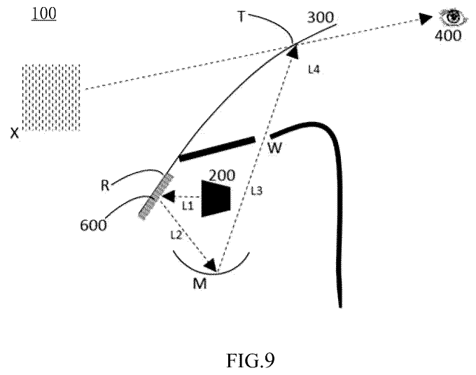

In some embodiments, the first light L1 does not intersect with the third light L3, as shown in FIG. 9, which is a schematic diagram of still another head-up display system 100 provided by an embodiment of the present disclosure, first light L1 emitted from the imaging unit 200 is directed to the reflection portion R. The reflective layer 600 with a reflective function is provided on a surface of the reflection portion R facing the imaging unit 200. The first light L1 is reflected by the reflective film layer 600 to form second light L2. Then, the second light L2 is reflected to the reflector M, and is then reflected by the reflector M to form third light L3. Then, the third light L3 is directed to the transmission portion T of the windshield 300, and is finally reflected by the transmission portion T of the windshield 300 to form fourth light L4, which is converged in the vicinity of the position of the human eye 400 of the driver, thereby realizing the display function.

In the embodiments, the light emitted from the imaging unit 200 is S-polarized light or P-polarized light. Since the first light L1 does not intersect with the third light L3 and does not intersect with other light in the optical path. Therefore, there is no need to provide a quarter-wave plate or other form of optical film to avoid light interference, and the polarization directions of the first light L1, the second light L2, the third light L3 and the fourth light L4 are the same. Therefore, the brightness of the head-up display system 100 can be improved.

In order to adapt to drivers with different heights and drivers with different sitting postures, the embodiments of the present disclosure further include an image height adjustment structure for adjusting the imaging height, and the image height adjustment structure is provided on the reflector M.

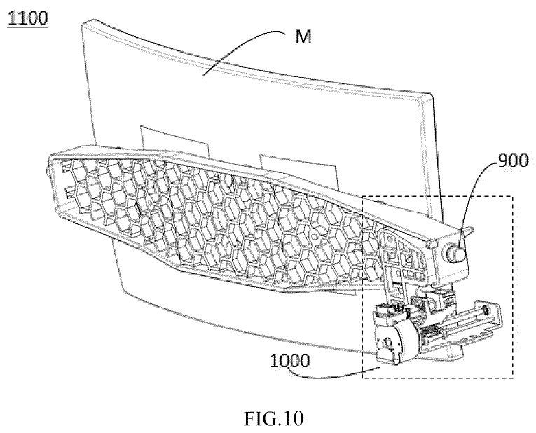

As shown in FIG. 10, the image height adjusting structure 1100 is provided on the reflector M for adjusting an angle of the reflector M. In an embodiment, the image height adjusting structure 1100 includes a rotating shaft 900 and an electric adjusting mechanism 1000. The rotating shaft 900 is provided at the middle part of the reflector. The reflector can rotate by means of the electric adjusting mechanism 1000 located at the lower end of the reflector, thereby changing an angle of the reflected imaging light of the reflector M, changing the position of the imaging light reflected to the windshield 300, and thus changing the imaging height of the head-up display system.

In some embodiments, as shown in FIG. 2, the imaging unit 200 is a cuboid or trapezoidal platform as a whole, and the imaging unit 200 is an image source for providing image light by the head-up display system 100. The imaging unit 200 is provided inside the instrument panel or the center console of the vehicle, faces the reflection portion R1 of the windshield 300, and directs imaging light to the reflection portion R. An included angle between the first light L1 emitted from the imaging unit 200 and a direction perpendicular to the reflection portion R is a first incident angle α1, and the first incident angle is greater than 10° and less than 45°. In an embodiment, an angle of the first incident angle α1 is greater than 15° and less than 35°. For example, as shown in FIG. 2, the angle of the first incident angle α1 is 25°.

The reflector M receives the second light L2 of the imaging light from the reflection portion R, and reflects the imaging light to the transmission portion T of the windshield 300, and after being reflected by the transmission portion T, the imaging light is directed to the vicinity of the human eye 400 of the driver, thereby realizing the head-up display. An included angle between the second light L2 reflected by the reflection portion R to the reflector M and the direction perpendicular to the reflector M is a second incident angle α2, and the angle of the second incident angle α2 is greater than 10° and less than 45°. In an embodiment, an angle of the second incident angle α2 is greater than 15° and less than 35°. For example, as shown in FIG. 2, the angle of the second incident angle is 20°.

The transmission portion T receives the third light L3 of the imaging light from the reflection portion R, and reflects the imaging light to the transmission portion T of the windshield 300, and after being reflected by the transmission portion T, the imaging light is directed to the vicinity of the human eye 400 of the driver, thereby realizing the head-up display. An included angle between the third light L3 reflected by the reflector M to the transmission portion T and the direction perpendicular to the transmission portion T is a third incident angle α3, and the angle of the third incident angle α3 is greater than 50° and less than 70°. In an embodiment, an angle of the third incident angle α3 is greater than 55° and less than 65°. For example, as shown in FIG. 2, the angle of the third incident angle is 60°.

Due to the similarity in the imaging optical path structure between head-up display (HUD) of the vehicle and Medium-Free Holographic Display (VPA) based on the vehicle windshield, the solutions described in the present disclosure are also applicable to the VPA imaging optical path structure based on the vehicle windshields. The VPA imaging optical structure based on the embodiments of the present disclosure shall be included within the scope of the present disclosure.

According to the above technical solutions of the present disclosure, a generation unit, a reflector and a windshield are included. The windshield includes a transmission portion and a reflection portion. The reflection portion is located in an optical path between an imaging unit and the reflector. An imaging light beam emitted from the image generation unit is directed to the reflection portion, then is reflected to the reflector, then is reflected to the transmission portion of the windshield, and finally is converged at the eye position of a driver to realize a display function. In this case, within a same HUD imaging field of view (FOV), the present disclosure can realize a smaller product volume, which can be arranged in more vehicles, so that the contradiction between achieving a large image and achieving a small volume in the HUD industry can be solved. In addition, according to the technical solutions of the present disclosure, a larger display image can be achieved with a similar product volume, and can bring a larger FOV and make the ARHUD screen wider and higher, thereby covering more and farther lanes. When there are dangerous factors during vehicle driving, the factors can be projected on the ARHUD earlier, and the driver can receive early warnings, thereby improving the safety of vehicle driving.

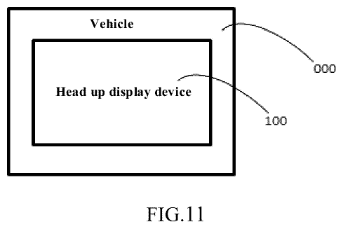

FIG. 11 is a schematic diagram of a vehicle according to an embodiment of the present disclosure. As shown in FIG. 11, the vehicle 000 includes the head-up display system 100 of the above-described embodiments, and the structure and imaging principle of the head-up display system 100 may refer to the description of the above embodiments, and details are not described herein again.

According to the embodiments of the present disclosure, the vehicle 000 adopts the head-up display system 100 of the above-described embodiments, which can realize floating real image display, and provide a large-size display image, thereby improving user's experience. In addition, the human-computer interaction function can also be realized through the interaction device of the head-up display system 100, so that the drivers can realize operation without lowering their heads, especially in the driving process, which can improve driving safety.

The above description of the embodiments of the present disclosure enables those skilled in the art to implement or use the present disclosure. Various modifications to these embodiments will be apparent to those skilled in the art, and the general principles defined herein may be implemented in other embodiments without departing from the spirit or scope of the present disclosure. Accordingly, the present disclosure will not be limited to the embodiments described herein, but should be interpreted to have the broadest scope in conformity with the principles and innovations disclosed in the present disclosure.

What is claimed is:

1. A head-up display system, comprising:
an imaging unit;
a reflector; and
a windshield of a vehicle,
wherein the windshield comprises a reflection portion and a transmission portion; the imaging unit forms first light and emits the first light to the reflection portion, the reflection portion reflects the first light to form second light, the reflection portion reflects the second light to the reflector, the reflector reflects the second light to form third light, the reflector reflects the third light to the transmission portion to form fourth light, the transmission portion reflects the fourth light to human eyes, and the fourth light forms a virtual image at a side of the windshield facing away from the human eyes.

2. The head-up display system according to claim 1, wherein the first light intersects with the third light.

3. The head-up display system according to claim 1, wherein the first light does not intersect with the third light.

4. The head-up display system according to claim 1, further comprising an instrument panel having an opening, wherein the imaging unit, the reflector and the reflection portion are all provided inside the instrument panel, and the third light is projected to the transmission portion through the opening.

5. The head-up display system according to claim 1, wherein the reflection portion is on a lower side of the windshield, and the reflection portion comprises a reflective layer.

6. The head-up display system according to claim 5, wherein the reflective layer is provided at a side of the reflection portion close to the human eye.

7. The head-up display system according to claim 5, wherein the windshield comprises first glass plate and second glass plate, and the reflective layer is positioned between the first glass plate and the second glass plate.

8. The head-up display system according to claim 7, wherein the windshield further comprises a wedge-shaped film, the wedge-shaped film is arranged between the first glass plate and the second glass plate, the reflective layer is arranged between the wedge-shaped film and the first glass plate, and the first glass plate is closer to the human eye.

9. The head-up display system according to claim 5, wherein the reflective layer comprises one or more of a coating film, a transfer film, a screen printing film, a sputtering film, or an evaporation coating film.

10. The head-up display system according to claim 5, wherein the reflective layer comprises one or more of aluminum, silver, aluminum alloy, or silver alloy material.

11. The head-up display system according to claim 2, wherein the reflection portion is provided with a quarter-wave plate.

12. The head-up display system according to claim 2, wherein the reflector is provided with a quarter-wave plate.

13. The head-up display system according to claim 2, wherein the first light, the second light, the third light and the fourth light each are polarized light, and the first light and the third light have different polarization directions.

14. The head-up display system according to claim 3, wherein the first light, the second light, the third light and the fourth light each are polarized light, and the first light, the second light and the third light have a same polarization direction.

15. The head-up display system according to claim 13, wherein a polarization direction of the first light is perpendicular to a polarization direction of the third light.

16. The head-up display system according to claim 1, wherein the first light and the reflection portion form a first included angle, and the first included angle is within a range from 10° to 45°.

17. The head-up display system according to claim 16, wherein the second light and the reflector form a second included angle, and the second included angle is within a range from 10° to 45°.

18. The head-up display system according to claim 17, wherein the third light and the transmission portion form a third included angle, and the third included angle is within a range from 50° to 70°.

19. The head-up display system according to claim 1, wherein the imaging unit is a liquid crystal displayer, and the liquid crystal displayer comprises: a liquid crystal box, an upper polarizer and a lower polarizer located at upper and lower sides of the liquid crystal box; and an absorption axis of the upper polarizer is perpendicular to an absorption axis of the lower polarizer.

20. A vehicle, comprising a head-up display system, comprising:
an imaging unit;
a reflector; and
a windshield,
wherein the windshield comprises a reflection portion and a transmission portion; the imaging unit forms first light and emits the first light to the reflection portion, the reflection portion reflects the first light to form second light, the reflection portion reflects the second light to the reflector, the reflector reflects the second light to form third light, the reflector reflects the third light to the transmission portion to form fourth light, the transmission portion reflects the fourth light to human eyes, and the fourth light forms a virtual image at a side of the windshield facing away from the human eyes.
